(19) United States
(12) Patent Application Publication
(10) Pub. No.: US 2009/0294531 A1
(43) Pub. Date: Dec. 3, 2009

(54) CONTAINERIZED INVENTORY MANAGEMENT SYSTEM UTILIZING IDENTIFICATION TAGS

(76) Inventors: Allen B. Kantrowitz, Williamstown, MA (US); In Ki Mun, Nanuet, NY (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/396,968

(22) Filed: Mar. 3, 2009

Related U.S. Application Data
(63) Continuation-in-part of application No. 11/056,808, filed on Feb. 11, 2005.
Application No. 11/056,808 is a continuation-in-part of application No. 11/441,309, filed on May 25, 2006, now abandoned.
(60) Provisional application No. 60/558,629, filed on Apr. 1, 2004.
(60) Provisional application No. 60/684,276, filed on May 25, 2005.

(51) Int. Cl. G06K 19/00; G06F 19/00

(52) U.S. Cl. 235/385; 206/459.1

(57) ABSTRACT

An inventory control process includes the association of an inventory item with a reusable container at an origination point. The container is inclusive of a passive or active identification tag. The container is transported within the range of a transponder able to share information with the identification tag. Upon reaching a destination point, the inventory item is unpacked from the container and the container recycled for association with a new inventory item. An inventory delivery device includes a reusable container labeled with an active identification tag. An inventory item is inserted within the container. A disposable tamper-evident seal retaining the inventory item with the container is provided. The device is particularly well suited for transportation for timely and high clinical value items within a medical care setting.

### CROSS-REFERENCE TO RELATED APPLICATIONS

This application is a continuation-in-part of U.S. patent application Ser. No. 11/441,309 filed May 25, 2006, which claims priority of U.S. Provisional Patent Application Ser. No. 60/684,276 filed May 25, 2005. This application is also a continuation-in-part of U.S. patent application Ser. No. 11/056,808 filed Feb. 11, 2005, which claims priority of U.S. Provisional Patent Application Ser. No. 60/558,629 filed Apr. 1, 2004. These aforementioned priority applications are hereby incorporated by reference.

### FIELD OF THE INVENTION

The present invention in general relates to the tracking of articles within an organization and in particular to a process for affixing an identifying label to a container and inventory associated with the container.

### BACKGROUND OF THE INVENTION

Radiofrequency identification (RFID) tags are broadly classed as to passive and active tags. While a passive tag lacks a power supply in electrical communication with the tag, an active identification tag has a coupled power supply and actively broadcasts a signal. Generally, a passive tag tends to be less expensive, more compact and has a longer operating lifetime than a comparable active tag, at the expense of requiring more complex tag interrogation systems. An impediment to the use of RFID tags in inventory management systems is the initial effort associated with individual inventory items and the comparative cost of tags relative to inventory items. While the cost of passive identification tags is generally comparatively lower than that of active tags, the cost of the tag and labor associated with affixing such tags remains considerable.

Thus, there exists a need for an inventory management system that provides for the efficient reuse of identification tags while avoiding the need to affix an individual tag to each inventory item or lot.

### SUMMARY OF THE INVENTION

An inventory control process includes the association of an inventory item with a reusable container at an origination point. The container is inclusive of a transponder equipped optical identification tag. The container is transported within the range of a transponder able to share information with the identification tag. Upon reaching a destination point, the inventory item is unpacked from the container and the container recycled for association with a new inventory item.

An inventory delivery device includes a reusable container labeled with an active identification tag. An inventory item is inserted within the container. A disposable tamper-evident seal retaining the inventory item with the container is provided. The device is particularly well suited for transportation for timely and high clinical value items within a medical care setting.

### BRIEF DESCRIPTION OF THE DRAWING

FIG. 1 is a schematic diagram of the steps involved in practicing the present invention;

FIG. 2 is a partial cutaway view of an inventive recyclable tagged container;

FIG. 3 is a schematic diagram of a preferred embodiment showing an integrated circuit with functions supporting its role as an optical transponder-equipped ID (OID) tag;

FIG. 4 is a schematic diagram of an alternate embodiment showing an integrated circuit with functions supporting multiple optional application uses as an optical transponder-equipped ID tag, an RFID tag or a combination O/RFID tag;

FIG. 5 is a schematic diagram of an alternate embodiment of the invention operating as a passive optical identification tag; and

FIG. 6 is a schematic diagram of an alternate embodiment of the invention operating as an optical transponder-equipped ID (OID) tag differing from that embodiment depicted in FIG. 3 in that the outgoing optical signal is produced by reflecting and modulating the incoming optical signal rather than being produced de novo.

### DETAILED DESCRIPTION OF THE PREFERRED EMBODIMENTS

The present invention has utility as an inventory management system that efficiently reuses identification tags and limits handling associated with tag affixation. These improvements are achieved by affixing a radiofrequency identification (RFID) or a transponder equipped optical identification tag onto a reusable bin or container. It is appreciated that dimensions, construction materials and shape are largely dictated by the particulars of the inventory items to be handled. The items entered into a tagged container are noted by a conventional technique such as manual recordation or barcode scanning. The items are then associated with the identification tag. As the inventory associated container moves through an organization, the location of the container and therefore the associated contents are noted.

The present invention is particularly well suited for inventory management in complex organizational settings with individualized and small lot delivery of goods. Organizations well suited to benefit from the present invention illustratively include hospitals and customized manufacturing facilities. The tracking of high clinical value materials or time-sensitive materials in a medical setting is of particular concern. Such materials illustratively include medications, blood or tissue samples, radioactive reagents, and medical procedure kits.

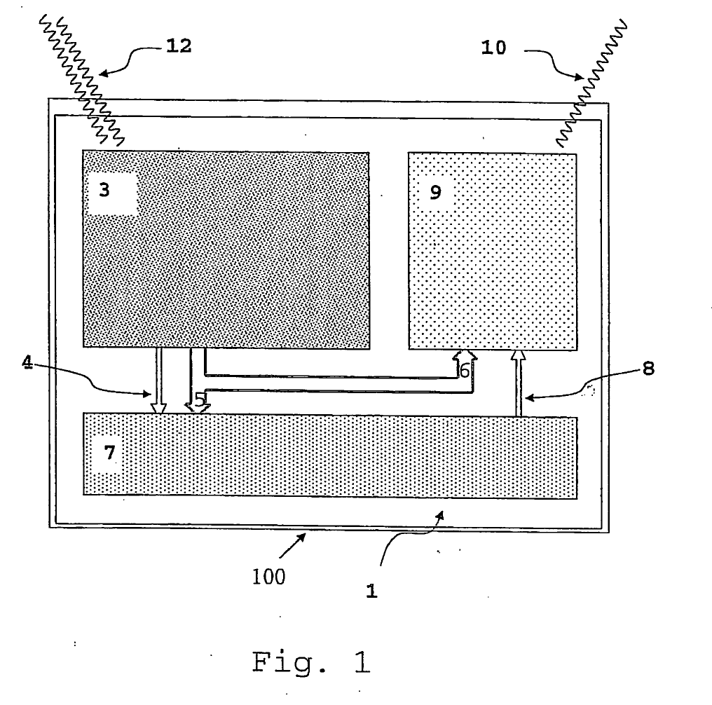

Referring now to FIG. 1, an inventive process is disclosed generally at 10. The placing of at least one inventory item in connection with a container having an identification tag 12 includes associating each inventory item with a respective container tag 14. The association is readily performed by manual data entry onto paper or a computer, or preferably through the use of optical or magnetic barcode reading. After associating inventory items with a container identification tag 14, the container is transmitted through the supply system 16.

Preferably, the tag 14 is an active tag. An active tag is more preferably rechargeable. Recharging is readily performed by exposing a tag ultra capacitor to the electrical field associated with a recharging coil. Alternatively, a passive tag is interrogated by a proximal reader encountered at a transit terminus or in transit.

During transportation of the container, it is brought within communicative proximity to a transponder 18 so as to provide near real-time tracking of the container en route and identification of transportation bottlenecks within the system. It is appreciated that the nature of the transponder operative herein is dependent on whether the identification tag is radiofrequency or optical, active or passive. At the end of container transport, the container arrives at the destination where the individual inventory items associated with the container are unpacked and the container recycled for another delivery 20. Container integrity in the course of transport is maintained by securing the container with a tamper-resistant seal to prevent inventory pilfering and/or loss en route.

It is appreciated that delivery time scheduling is readily performed such that containers arrive at the time of need, thereby decreasing the distributed inventory of inventory items stocked in wards, surgical suites, or treatment settings. Further, containers are readily prioritized within a delivery system. The performance of active checks of timetable delivery scheduling is performed to assess container flow. A check typically involves detection of all containers within the delivery system at a particular time. Periodic delivery checks are used as input data to a neural network routing program to efficiently utilize delivery bandwidth.

The inventive system is particularly well suited for use with a pressurized tube delivery system. Use of the inventive system in conjunction with a tube delivery system in a preferred embodiment utilizes a neural network routing controller that is self-learning in assembling optimal routes between source and destination for a particular container. Self-learning route control programs and the underlying methodologies are conventional to the art.

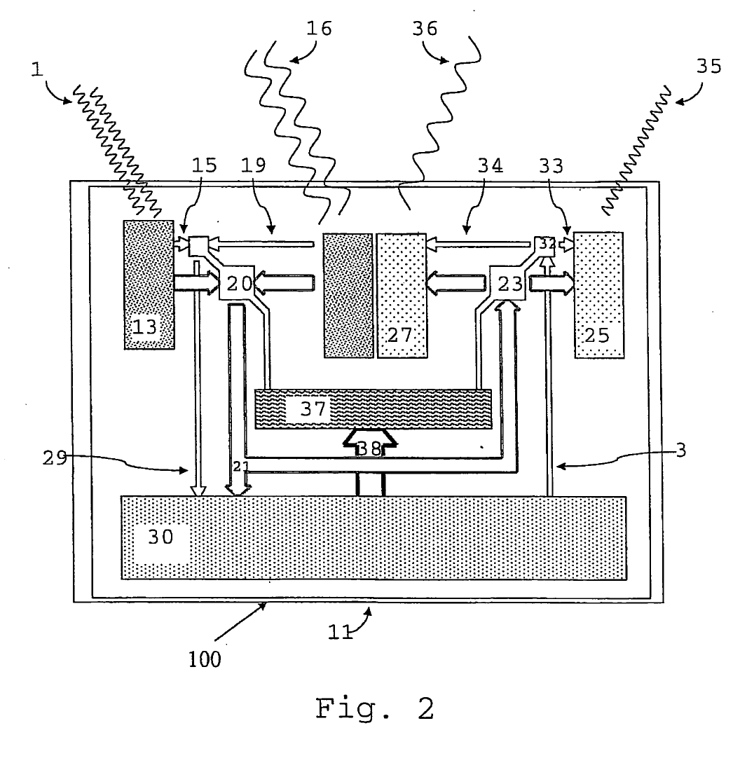

Referring to FIG. 2, an inventive container is shown generally at 30 where the container tag 14 is as described with respect to FIG. 1. The container 30 has a bottom 32 and a sidewall 34 defining a container volume 36. The volume 36 is adapted to receive an inventory item I such as those having a barcode. The sidewall 34 terminates in a mouth 38 engaging a cap 40. The cap 40 is secured to the mouth 38 by conventional means including complementary threads, press fit features, and a swivel mount. The tamper-evident or tamper-resistant seal 42 spans the interface between the cap 40 and sidewall 34. A high tack adhesive tape is well suited to function as a seal 40. The container tag 14 is secured into the container bottom 32 or sidewall 34. A tag 14 is readily potted with a curable resin to permanently adhere the tag 14 in place. Alternatively, a tag is adhered to a container surface with an adhesive tape or molded into the container. It is also appreciated that a tag 14 is associated with a swivel attached cap permanently attached to the container. Human cognizable coding 42 and/or bar coding 44 are optionally affixed to a container 30 allowing for integration with other coding and inventory handling systems.

The method of transmitting energy and signals between an ID tag and a corresponding interrogation device, hereafter referred to as “transmission mode”, can be distinguished from the informational functions of said tag. The term “transmission mode” is also intended to encompass directionality of transmission as in the terms “transmission mode into the tag” and “transmission mode away from the tag”. Transmission modes may include a novel transmission mode alone or in combination with a conventional mode such as RF. For example, a transponder-equipped ID tag with optical transmission modality optionally has a corresponding external interrogation device with powerful magnification lenses and photomultiplier technologies thereby allowing successful interrogation of the tag despite extremely small physical size and low power output of the tag.

As used herein, transponder ID tags are defined to be “informationally equivalent” if they report to their corresponding interrogating devices the same information despite have differing methods of transmission. Availability of such informationally equivalent tags is advantageous to an end user in that they would have available, beyond RF methods, alternate methods of transmission which may be better suited to specific applications and environments. Availability of such informationally equivalent tags is advantageous to end users in that they would have available several varieties of ID tags which are mutually compatible with respect to information content and external pre-interrogation and post-interrogation protocols and uses of the tag information. The directionality associated with an optical beam is intermediate between the area broadcast of an RF signal and the close proximity requirements of conventional barcode readers, and as such affords greater specificity in those tags subject to reading.

With the emergence of an RFID standards authority, a tag according to the present invention is readily tracked to a specific source. Owing to the data-carrying capacity of an optical or hybrid tag according to the present invention, a large number of tags are capable of rapid interrogation. The size of an inventive tag on the scale of 1 to 500 microns allows for the labeling of previously untaggable objects. Objects capable of incorporating an inventive tag include currency and production lots of products such as fertilizer, personal care products, plastics, consumer goods, tires, and glasses.

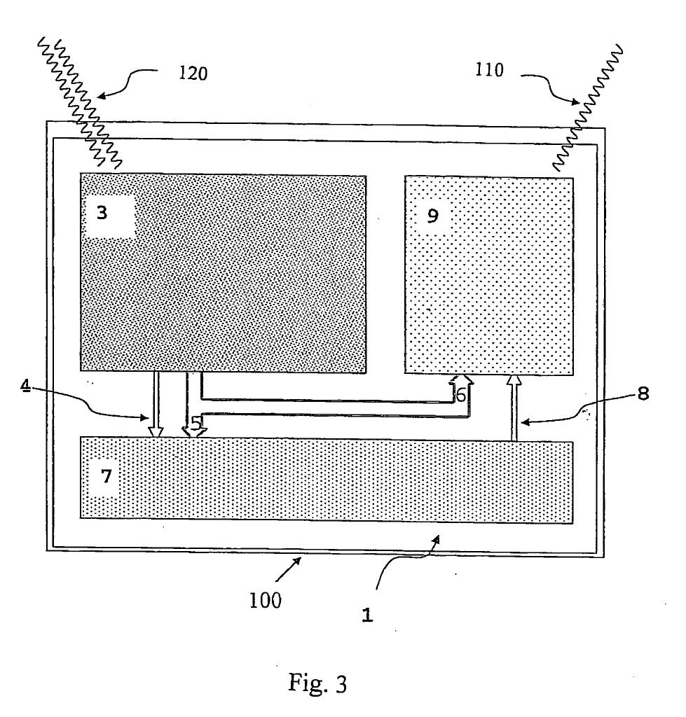

Referring now to FIG. 3, a substrate 1 is provided which carries the components of the optical identification (OID) tag. The method of manufacture is preferably from a monolithic integrated circuit; yet various other methods of manufacture are operative herein.

An incoming optical signal 2 is of wavelengths ranging from ultraviolet through visible to infrared. Its external source is monochromatic, for example a laser or photodiode, or polychromatic. An outgoing optical signal 110 is of wavelengths ranging from ultraviolet through visible to infrared. The optical transmitter 9 may be monochromatic, for example a laser or photodiode, or may be polychromatic. There is no requirement that the operating wavelength of the incoming optical signal and the outgoing optical signal be the same or different. Preferably, the outgoing signal is of a wavelength equal to or greater than the incoming signal, else a frequency doubling crystal is used. Both the incoming optical signal 2 and the outgoing optical signal 110 pass through an optional encapsulation 100 of the OID. Said encapsulation is optically transparent at the wavelengths appropriate to the combination of the incoming optical signal 2 and the optical energy receiver 3 as well the combination of the optical transmitter 9 and the outgoing optical signal 110. The encapsulation is optionally partially or completely during use. Optionally, the encapsulation may be opaque with a window transparent at the corresponding wavelengths provided in the field of view of the optical energy receiver 3 and the optical transmitter 9. Optionally, optical filtering (not illustrated) may be incorporated.

The optical energy receiver 3, containing a photosensitive structure, a coupling mechanism, a signal demodulator and a contained energy storage device, permits both power 5, 6 and signal 4 to be derived from the incoming optical energy 2. The power is delivered 5 to the information processing mechanism 7 and is delivered 6 to the optical transmitter 9. The information processing mechanism according to the present invention is encoded with information through techniques conventional to microelectronics and represents either physical or programmed encoding. Tag encoding illustratively includes a mechanism fashioned as an EPROM, uploaded software, and reconfigurable signal and/or power routing. Additional destinations and routings for the power are operative herein. The signal 4 is delivered to the information processing mechanism. Optionally, additional signals (not illustrated) are channeled directly between the optical energy receiver 3 and the optical transmitter 9. It is appreciated that additional destinations (not illustrated) and routings (not illustrated) for the signal are possible but are not included in FIG. 3 for visual simplification.

The information processing mechanism 7 delivers output 8 to the optical transmitter 9 and, optionally, delivers feedback information to the optical energy receiver 3 to alter the characteristics of the optical energy receiver 3. The information processing mechanism 7 may simply deliver an arbitrary number that had been recorded at time of manufacture or recorded at some later time. Alternatively, the information processing mechanism 7 may contain more elaborate informational functions such as encryptation, computation, environmental measurement and the like, as are commonly found resident on prior art RFID tags. It is appreciated that conventional information processing mechanisms are operative herein.

The optical transmitter 9 receives power 6 and signal 8 as described above and produces an outgoing optical signal 10 which is detected by an external interrogation device, such as an optical receiver.

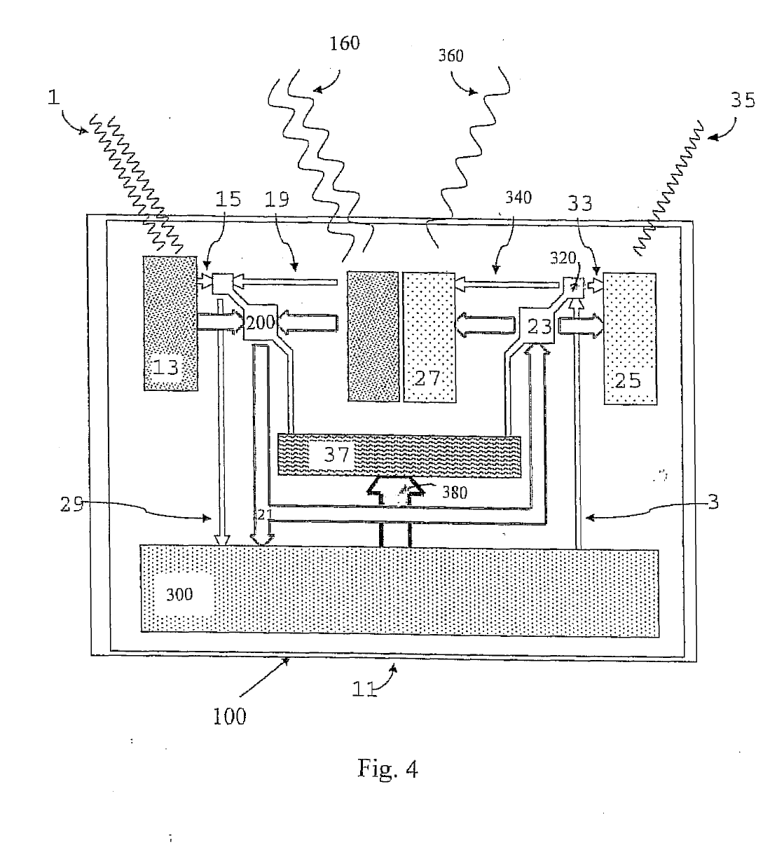

Another preferred embodiment of the invention is schematically diagrammed in FIG. 4. In this embodiment, the OID functions described in reference to FIG. 3 are augmented by inclusion of an RF transmitter into and away from the tag, optionally a method for enabling any combination of optical and RF reception and transmission. This embodiment will be referred to as an “O/RFID tag”.

This preferred embodiment of the invention is schematically diagrammed in FIG. 4. A substrate 11 is provided which carries the components of the O/RFID tag. The method of manufacture is preferably a monolithic integrated circuit; various methods of manufacture are permitted within the scope of the invention.

An incoming optical signal 120 is of wavelengths ranging from ultraviolet through visible to infrared. Its external source is monochromatic, for example a laser or photodiode, or polychromatic. An outgoing optical signal 35 is of wavelengths ranging from ultraviolet through visible to infrared. The optical transmitter 25 may be monochromatic, for example a laser or photodiode, or may be polychromatic. There is no requirement that the operating wavelength of the incoming optical signal and the outgoing optical signal be the same or different. Both the incoming optical signal 120 and the outgoing optical signal 35 pass through an optional encapsulation of the O/RFID tag. Said encapsulation 100 is optically transparent at the wavelengths appropriate to the combination of the incoming optical signal 120 and the optical energy receiver 13 as well the combination of the optical transmitter 25 and the outgoing optical signal 35. The encapsulation 100 is optionally partially or completely during use. An encapsulant 100 illustratively includes glass. Optionally, the encapsulation 100 is opaque and a transparent window is provided in the field of view of the optical energy receiver 13 and the optical transmitter 25. Optionally, optical filtering may be incorporated. An incoming RF signal 160 is of convenient wavelength as are commonly used in conventional RFID tags. An outgoing RF signal 360 is of convenient wavelength as are commonly used in conventional RFID tags. There is no requirement that the operating wavelength of the incoming RF signal and the outgoing RF signal be the same or different. Both the incoming RF signal 160 and the outgoing RF signal 360 pass through a conventional antenna connected to the O/RFID tag. As in conventional RFID tags, a single antenna may serve both to receive and transmit RF signals or separate antennas may be provided. As in conventional RFID tags, the antenna or antennas may be integrated onto the same substrate carrying the tag mechanisms or said antennas may optionally be carried beyond the substrate onto adjacent items where it may serve as an extended antenna or as the basis for additional functions such as security indicators and the like.

The optical energy receiver 13, containing a photosensitive structure, a coupling mechanism, a signal demodulator and a contained energy storage device, permits both power 14 and signal 15 to be derived from the incoming optical energy 120. The inventive RF energy receiver 17, connected to an antenna, a coupling mechanism, a signal demodulator and a contained energy storage device, permits both power 180 and signal 19 to be derived from the incoming RF energy 160. Power derived from the optical energy receiver 140 and power derived from the RF energy receiver 180 converge to a common power mechanism 200. Optionally, the function of the energy storage device contained within the optical energy receiver and the function of the energy storage device contained within the RE energy receiver may be combined in a single energy storage device, for example an electrical capacitor, which is located within the common power mechanism 200, The common power mechanism 200 is controlled via an apparatus which is schematically indicated 37. The common power mechanism outputs power which is distributed via power conduits 21, 22, 24, 26 and power distribution nodes 23 throughout the O/RFID tag. Said power distribution nodes 23 are controlled via an apparatus that is schematically indicated 37. Power is delivered 21 to the information processing mechanism 30 and is delivered 22 to a power distribution node 23 and then onward towards 24 the optical transmitter 25 and towards 26 the RF transmitter 27. Additional destinations (not illustrated) and routings (not illustrated) for the power are possible but are not included in FIG. 2 for visual simplification. Signal 15 emerging from the optical energy receiver 13 and signal 19 emerging from the RE energy receiver 17 converge to a common signal mechanism 28 controlled via an apparatus which is schematically indicated 37. From the common signal mechanism 28, information is delivered 29 to the information processing mechanism. It is appreciated that additional destinations and routings for signals are possible but are not included in FIG. 4 for visual simplification.

The information processing mechanism 300 delivers its signal output 31 to a signal output switch 320 controlled via an apparatus which is schematically indicated 37. From the signal output switch 320, signal information is routed 33, 340 to either the optical transmitter 25 and/or the RF transmitter 27. Optionally, the information processing mechanism 300 delivers additional signal information 380 to the control apparatus 37 and delivers additional signal information to the energy receivers 13, 17 and energy transmitters 25, 27 to alter their respective characteristics. The information processing mechanism 300 may simply deliver an arbitrary number which had been recorded at time of manufacture or recorded at some later time. Alternatively, the information processing mechanism 300 may contain more elaborate informational functions such as encryptation, computation, environmental measurement and the like, as are commonly found resident on conventional RFID tags.

The optical transmitter 25 receives power 24 and signal 33 as described above. It produces an outgoing optical signal 35 which is detected by an external interrogation device. The RF transmitter 27 receives power 26 and signal 340 as described above. It produces an outgoing RE signal 360 which is detected by an external interrogation device.

An apparatus 37 is provided to control the characteristics and activation of functional modules of the O/RFID tag. Indicated in FIG. 4 are power controllers 200, 23 and signal switches 28, 320 controlled by the apparatus 37. The apparatus 37 can be reversibly or irreversibly programmed at the time of manufacture or at some later time. Optionally, information provided 380 by the information processing mechanism 300 can be used to program appreciated that additional sources and routings for information to be used to program the apparatus are operative herein.

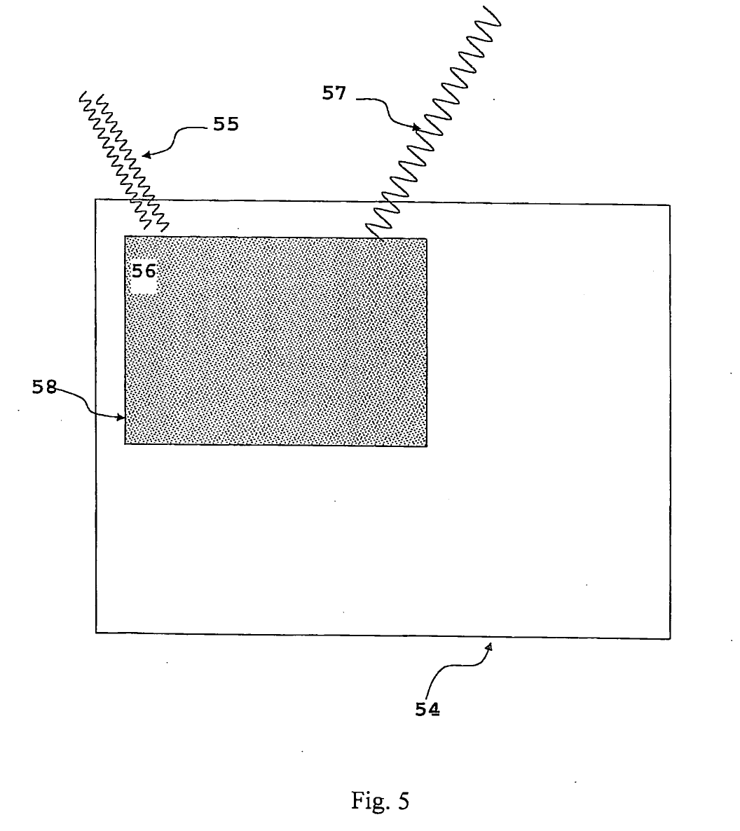

In an alternate embodiment depicted with respect to FIG. 5, a passive optical identification tag is shown generally at 54. An incoming optical signal 55 is provided of a wavelength ranging from ultraviolet through visible to infrared. The source of the incoming optical signal 55 is appreciated to be monochromatic, for example a laser or photodiode, or polychromatic, as obtained from an incandescent light source. The passive optical identification tag 54 includes an optical retroreflective transponder 56 that interacts with the incoming optical signal 55 to return a reflected output signal 57 communicating an identification code therewith. Methods of encoding a tag with a unique code illustratively include the deposition of bandpass filter coatings onto a reflective surface of the passive optical identification tag 54; the placement of one or more dye molecules onto a surface 58 of the transponder 56, the dye molecules being stimulated by the incoming optical signal 55 so as to emit a characteristic reflection wavelength, fluorescence, or phosphorescence; and scoring the reflective surface 58 to create light scattering of an incoming optical signal of a predetermined magnitude.

A passive optical identification tag 54 interrogated by a polychromatic light source coated with at least one optical bandpass filter material upon reflection of an incoming optical signal 55 will return a reflected optical signal 57 with only portions of the incident incoming optical signal 55 being present. Typical channel band centers for miscible light filters are 450 nanometers and progressing at 50 nanometer increments so as to create channel bandwidths of approximately 20 nanometers. Based on the filter bandwidth and the number of coatings available, used in combination with the polychromatic light source, an inventive passive optical tag is capable of encoding dozens of unique descriptor codes. The production of a bandpass passive optical identification tag according to the present invention is readily accomplished through the coating of a reflective metal or semiconductor substrate having a known reflectivity with layers of optical filter coatings. It is appreciated that the substrate is in the form of a wire, wafer, or particle. Organic optical filter coatings are readily applied through dip or spin coating, while inorganic optical filter coatings are typically applied through chemical vapor deposition, physical vapor deposition, or sputter coating. In the case of a wire or wafer substrate, the substrate is thereafter divided to be sized on the order of 1 to 500 microns. It is further appreciated that the passive optical tag is readily encapsulated within a protective coating that if optically transparent allows for interrogation of the passive optical identification tag 54 or alternatively is removed upon recovery of the tag and prior to incoming optical signal interrogation.

A passive optical identification tag according to the present invention coated with dye molecules having characteristic absorption, fluorescent, or phosphorescent signatures are prepared in a like manner to those described above having optical bandpass coatings thereon. It is appreciated that a passive optical identification tag according to the present invention is readily produced that has a combination of preselected dye molecules coated thereon and bandpass filters. Dye molecules operative herein include any organic, inorganic, or organometallic compound that is not ubiquitous to the tag environment, has a degradation lifetime in the tag environment on a timescale suitable for labeling, and a known absorption and/or emission spectrum under incoming optical signal illumination. With the use of dye species, it is appreciated that the passive optical identification tag need not be reflective, and instead a porous silica, aerogel, or colloidal substrate containing dye molecules is operative herein. In the instance of dye labeled passive optical tags, it is appreciated that time resolve labeling is readily accomplished with a dye having a comparatively short lifetime in the tag environment prior to degradation. Through application of Beer's Law and a known initial quantity of dye associated with the tag, the time from labeling until interrogation is readily extrapolated subject to variations in tag environment and individual tag exposures. Alternatively, temporal labeling of a tag is provided by varying the quantity of each of two or more dyes that are applied to a particular tag in a preselected amount that varies with time. The relative signals received from interrogating the tag are then correlated with the concentration of each dye present in order to extract the time of label. It is appreciated that a passive optical tag including dye species is interrogated with either monochromatic or polychromatic incoming optical signals, depending on the physical property by which a returned optical signal is generated.

A passive optical tag having a light scattering grating associated therewith is preferably formed by lithographic etching of a reflective metal or semiconductor substrate. However, it is appreciated that a grating structure is readily cast onto a wafer substrate using a grating mold as is common to the optical arts. With a grating type passive optical identification tag, the measure of the incident incoming optical signal relative to the reflected optical signal at a preselected angular orientation is sufficient to read the code from a given optical tag. It is appreciated that an optical grating type passive optical identification tag is operative alone or in combination with bandpass filter coatings and/or dye species associated therewith. Additionally, as detailed above, a grating type passive optical identification tag is readily encapsulated to protect the grating structure until such time as interrogation is intended.

A passive optical identification tag interrogation system as detailed above includes a monochromatic or polychromatic light source. Interrogation of the reflected optical signal from a tag is preferably accomplished with a spectrophotometer. Owing to the small size of an individual inventive tag, interrogation from a field of view potentially containing a large number of tags is readily accomplished with a microscope delivering instant light and receiving reflected light by way of optical fibers. In this way, a taggant is spatially resolved within a field. Placing the optical stage and optic system under the control of a computer operating an algorithm to identify tags within the optical field affords automated interrogation of tags within the field. Coupling the motor driven and computer controlled stage with a robotic arm capable of placing sample slides from the stage allows for the automated screening of samples with the interrogation of tags found on each of the samples.

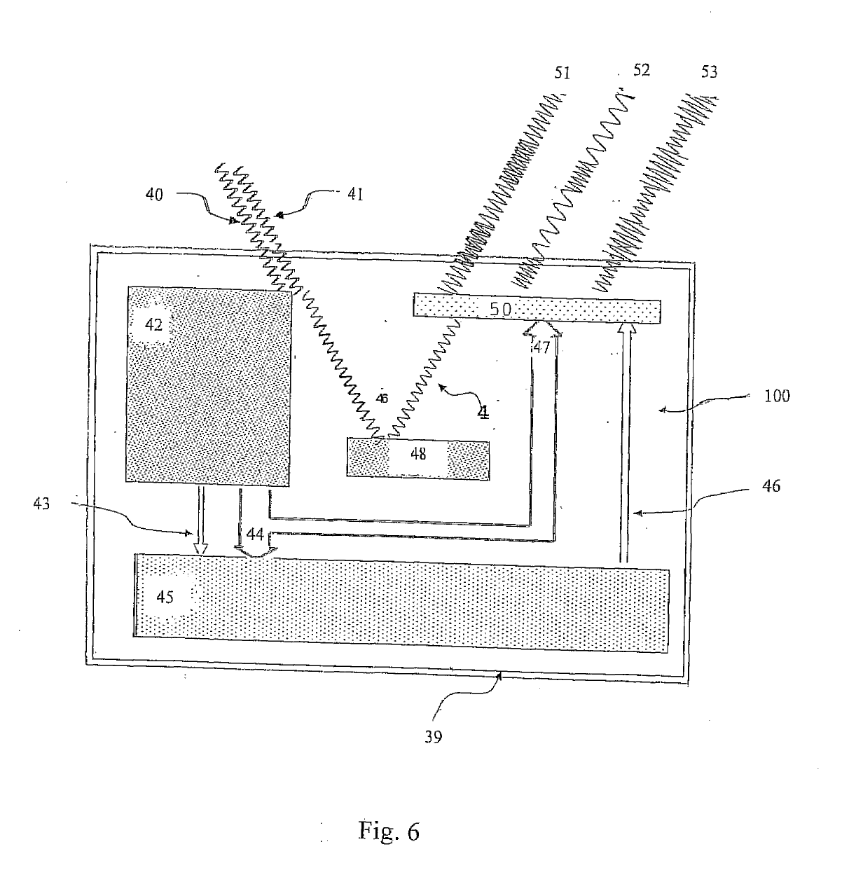

Depicted in FIG. 6 is an alternate embodiment of the invention as depicted in FIG. 3 in which is substituted, for the outgoing optical transmitter identified as component 9 in FIG. 3, a reflector 48 and an optical modulator 50. A substrate 39 is provided which carries the components of the optical identification (OID) tag. The method of manufacture is preferably a monolithic integrated circuit; yet various other methods of manufacture are operative herein.

An incoming optical signal 400, 41 is of wavelengths ranging from ultraviolet through visible to infrared. Its external source is monochromatic, for example a laser or photodiode, or polychromatic. One portion of the incoming optical signal 400 is captured by a optical energy receiver 420 and another portion of the incoming optical signal 41 strikes a reflective surface 48 and then continues on 49 to be modulated by an optical beam modulator 50. An outgoing optical signal 51, 52, 53 is of wavelengths ranging from ultraviolet through visible to infrared. The optical reflector 48 may be integrated with the other components in a monolithic structure or may be external to the other components. The optical modulator 50 may be integrated with the other components in a monolithic structure or may be external to the other components. The modulator 50 may be transmissive as depicted in FIG. 4 or may be reflective (not illustrated). Should the modulator be reflective, then its function can be merged with that of the reflector 48 to provide a combination reflector/modulator (not illustrated). The optical modulator encodes information on the outgoing reflected optical signal 51, 52, or 53 by varying any combination of the phase, wavelength, and/or intensity of the incoming signal 41. There is no requirement that the operating wavelength of the incoming optical signal and the outgoing optical signal be the same or different. Both the incoming optical signal 400, 41 and the outgoing optical signal 51, 52, 53 pass through an optional encapsulation 100 of the OID. Said encapsulation 100 is optically transparent at the wavelengths appropriate to the combination of the incoming optical signal 40, 41 and the optical energy receiver 420 as well the combination of the optical reflector 48, optical modulator 50 and the outgoing optical signal 51, 52, 53. The encapsulation is optionally partially or completely during use. Optionally, the encapsulation 100 may be opaque with a window transparent at the corresponding wavelengths provided in the field of view of the optical energy receiver 420, optical reflector 48 and the optical modulator 50. Optionally, optical filtering (not illustrated) may be incorporated.

The optical energy receiver 420, containing a photosensitive structure, a coupling mechanism, a signal demodulator and an optional contained energy storage device, permits both power 44, 47 and signal 43 to be derived from a portion of the incoming optical energy 400. The power derived from the incoming optical energy is available to energize the mechanisms of the transponder as illustratively indicated by 44, indicating energy delivery to the information processing mechanism 45, and by 47 indicating energy delivery to the optical modulator 50. The information processing mechanism 45 according to the present invention is encoded with information through techniques conventional to microelectronics and represents either physical or programmed encoding. Tag encoding illustratively includes a mechanism fashioned as an EPROM, uploaded software, and reconfigurable signal and/or power routing. Additional destinations (not illustrated) and routings (not illustrated) for the power are possible but are not included in FIG. 6 for visual simplification. The signal 43 is delivered to the information processing mechanism. Optionally, additional signals (not illustrated) are channeled directly between the optical energy receiver 420 and the optical modulator 50. It is appreciated that additional destinations (not illustrated) and routings (not illustrated) for the signal are possible but are not included in FIG. 6 for visual simplification.

The information processing mechanism 45 delivers its output 46 to the optical modulator 50 and, optionally, delivers feedback information (not illustrated) to the optical energy receiver 420 to alter the characteristics of the optical energy receiver 420. Additional destinations (not illustrated) and routings (not illustrated) for the information are possible but are not included in FIG. 6 for visual simplification. The information processing mechanism 45 may simply deliver an arbitrary number that had been recorded at time of manufacture or recorded at some later time. Alternatively, the information processing mechanism 45 may contain more elaborate informational functions such as encryptation, computation, environmental measurement and the like, as are commonly found resident on prior art RFID tags. It is appreciated that conventional information processing mechanisms are operative herein.

The optical modulator 50 receives power 47 and signal 46 as described above. Additional sources (not illustrated) and routings (not illustrated) for the power are possible but are not included in FIG. 6 for visual simplification. It produces an outgoing optical signal 51 which is detected by an external interrogation device.

In another alternate embodiment a reflector and an optical modulator, such as those described with respect to components 48 and 50 of FIG. 6, are substituted for the outgoing optical transmitter identified as component 25 in FIG. 4.

An interrogation device, external to the inventive tag, is provided. In one embodiment, mechanical guides hold a tag or a tagged item in a predetermined location and orientation. A laser illuminates the same predetermined position and a photodetector receives the outgoing optical signal. Further information processing is by conventional means. An alternate embodiment of the external interrogation device allows the interrogating laser beam to scan a range of positions in a space filling pattern. Optionally optical elements may be incorporated into the tag or the surface of the tagged item in order to simplify the recognition of the tag. Once the tag is located, further transmission and reception of optical signals proceeds as above. In an additional embodiment of the invention, optical means of interrogation can be combined with other means of interrogation including optical barcode, radiofrequency, acoustic and magnetic technologies. Other forms and configurations of external interrogating devices are possible and are included within this invention.

An inventive tag has met with considerable acceptance in situations where there is no tolerance for ambiguity as to the identity of the tag being read. The following exemplary usage further illustrates these advantages.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An inventory control process comprising:
associating at least one inventory item with a reusable container at an origination point comprising an optical transponder equipped identification tag;
transporting said container into a communicative range with at least one transponder able to share information with said identification tag;
unpacking said at least one inventory item from said container at a destination point; and
recycling said container to be associated with a new inventory item.

2. The process of claim 1 wherein association is performed by optical or magnetic scanning of said at least one inventory item and associating the scanned data with said identification tag.

3. The process of claim 1 wherein said optical transponder equipped identification tag comprises:
a substrate;
an information processing mechanism on said substrate and containing a datum;
an interrogating signal receiver for receiving an energy input outside the radiofrequency range; and
an output signal transmitter for communicating said datum external to said substrate as an emission outside the radiofrequency range.

4. The process of claim 3 wherein said receiver receives an optical energy input and said transmitter emission is optical.

5. The process of claim 3 wherein said receiver receives an optical energy input and said transmitter emission is magnetic.

6. The process of claim 3 wherein said receiver receives an optical energy input and said transmitter emission is piezoelectric.

7. The process of claim 3 further comprising a radiofrequency energy receiver yielding an RF power input and RF signal input, and a power control apparatus.

8. The process of claim 1 wherein transporting said container occurs through a portion of pressurized air tube.

9. The process of claim 8 wherein said pressurized air tube is found within a hospital.

10. The process of claim 1 further comprising applying a tamper-evident seal to said container prior to transportation thereof.

11. The process of claim 1 further comprising identifying an optimal route for transportation of said container with a self-learning route controller program operating on a computer.

12. The process of claim 11 wherein said route controller program is a neural network.

13. The process of claim 1 further comprising checking timetable delivery scheduling during the transporting of said container.

14. An inventory delivery device comprising:
a reusable container labeled with an optical transponder equipped identification tag;
an inventory item within said container; and
a disposable tamper-evident seal retaining said inventory item in association with said container.
